(19) United States
(12) Patent Application Publication
(10) Pub. No.: US 2003/0167312 A1
(43) Pub. Date: Sep. 4, 2003

(54) Method of copying data and recording medium including a recorded program for copying data

(76) Inventor: Yoshiaki Mori, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/950,768

(22) Filed: Sep. 13, 2001

(30) Foreign Application Priority Data
Sep. 13, 2000 (JP) 2000-278119

(51) Int. Cl. G06F 15/167; G06F 12/00; G06F 13/00

(52) U.S. Cl. 709/212; 711/112; 710/22

(57) ABSTRACT

In a method of copying data for connecting a host system with a plurality of devices through an interface, the method is for use in copying data between a plurality of devices based on a copy command produced in the host system, the copy command designates a copy source device and a copy destination device among a plurality of devices, at least one of the copy source device and the copy destination device is provided with data copy function to copy data between a plurality of devices by no way of the host system. A connected device management file which stores whether or not each of a plurality of devices has the data copy function is prepared in the host system. One of the copy source device and the copy destination device to have the data copy function with reference to the copy command and the connected device management file is selected to issue the copy command to the copy source device or the copy destination device which has the data copy function.

### BACKGROUND OF THE INVENTION

The present invention relates to a method of copying data and a recording medium including a recorded program for copying data, in particular to the method and the recording medium for data transmission or data copying that are required while backup or duplication of data is carried out between auxiliary storage devices for computers, such as a magnetic disk, a magnetic tape, and the like.

In a conventional method of copying data for a backup of data between auxiliary storage devices for computers, such as a magnetic disk and a magnetic tape, a host system for controlling the backup operation, for example, reads data from the magnetic disk and then writes the data to the magnetic tape. However, in the conventional method, since the host system once must read the data to be copied, the host system is subjected to the load. The other requirements for processing by the host system are threatened to be delayed while the host system is copying the data. In such a data copy, the host system is subjected to the load, although the host system does not need the data to be copied but only conveys the data from the magnetic disk to the magnetic tape.

In order to reduce the load on such a host system, a method of copying data is proposed in unexamined Japanese patent publication No.H06-236340, namely, 236340/1994. In the method of copying data, the opposite party of data transmission is indicated to both a copy source of data and a copy destination of data. The data transmission is actually conducted between the auxiliary storage devices. Accordingly, the data are transmitted not through the host system, so that the load on the host system is thereby reduced. However, as will later be described more in detail, the method of copying data proposed in the unexamined Japanese patent publication still has some problems.

Further, such a concept as Storage Area Network has recently been saturated. In the Storage Area Network, a plurality of host systems jointly own a plurality of peripheral devices by connecting many auxiliary storage devices with a network directly or through a switch. Under the circumstances, a computer network is greatly influenced by the above-mentioned delay of the other requirements for processing by the host system while amount of data to be processed is gradually increased. It is so desired that the load on the host system copying data is reduced.

### SUMMARY OF THE INVENTION

It is therefore an object of the present invention to provide a method of copying data and a recording medium including a recorded program for copying data each of which is capable of reducing not only load on a host system in data copy but also use rate (busy rate) in an interface.

It is another object of the present invention to provide a method of copying data and a recording medium including a recorded program for copying data each of which is capable of reducing use rate (busy rate) in an interface, when data copy or data transfer between peripheral devices is supported by the peripheral devices connected to an open system.

Other objects of the present invention will become clear as the description proceeds.

According to an aspect of the present invention, there is provided a method of copying data for use in connecting a host system with a plurality of devices through an interface, the method being for use in copying data between the a plurality of devices based on a copy command produced in the host system, the copy command designating a copy source device and a copy destination device among the a plurality of devices, the method comprising the steps of: providing at least one of the copy source device and the copy destination device with data copy function to copy the data between the a plurality of devices by no way of the host system; preparing a connected device management file which stores whether or not each of the a plurality of devices has the data copy function in the host system; selecting one of the copy source device and the copy destination device to have the data copy function with reference to the copy command and the connected device management file; and issuing the copy command to the copy source device or the copy destination device which has the data copy function.

According to another aspect of the present invention, there is also provided a method of copying data for use in connecting a host system with a plurality of devices through an interface, the method being for use in copying data between the a plurality of devices based on a copy command produced in the host system, the copy command designating a copy source device and a copy destination device among the a plurality of devices, the method comprising the steps of: connecting a copy manager with the interface, the copy manager being capable of data copy between the a plurality of devices by no way of the host system; providing at least one of the copy source device and the copy destination device with data copy function to copy the data between the a plurality of devices by no way of the host system; preparing a connected device management file which stores whether or not each of the a plurality of devices has the data copy function in the host system; selecting, if at least one of the copy source device and the copy destination device has the data copy function, one of the copy source device and the copy destination device to have the data copy function with reference to the copy command and the connected device management file, so that the copy command is issued to the copy source device or the copy destination device which has the data copy function; and selecting, if neither the copy source device nor the copy destination device has the data copy function, the copy manager, so that the copy command is issued to the copy manager.

According to yet another aspect of the present invention, there is also provided a method of copying data for use in connecting a host system with a plurality of devices through an interface, the method being for use in copying data between the a plurality of devices based on a copy command produced in the host system, the copy command designating a copy source device and a copy destination device among the a plurality of devices, the method comprising the steps of: connecting a copy manager with the interface, the copy manager being capable of data copy between the a plurality of devices by no way of the host system; providing at least one of the copy source device and the copy destination device with either data copy function or data transfer function, the data copy function being capable of copying data between the a plurality of devices by no way of the host system while the data transfer function being capable of transferring data between the a plurality of devices; preparing a connected device management file which stores whether or not each of the a plurality of devices has the data copy function and which stores whether or not each of the a plurality of devices has the data transfer function; selecting, if at least one of the copy source device and the copy destination device has the data copy function, one of the copy source device and the copy destination device to have the data copy function with reference to the copy command and the connected device management file, so that the copy command is issued to the copy source device or the copy destination device which has the data copy function; issuing a read command to the copy source device while issuing a write command to the copy destination device, if both the copy source device and the copy destination device have the data transfer functions, so that the data transfer functions are started to copy the data; and selecting, if neither the copy source device nor the copy destination device has the data copy function and the data transfer function, the copy manager, so that the copy command is issued to the copy manager.

According to still another aspect of the present invention, there is also provided a recording media for recording a program for copying data for use in connecting a host system with a plurality of devices through an interface, the program being for use in copying data between the a plurality of devices based on a copy command produced in the host system, the copy command designating a copy source device and a copy destination device among the a plurality of devices, at least one of the copy source device and the copy destination device being provided with data copy function to copy the data between the a plurality of devices by no way of the host system, the program comprising: a management file producing program for constituting a connected device management file in a memory of the host system, the connected device management file storing whether or not each of the a plurality of devices has the data copy function; a device selection program for selecting one of the copy source device and the copy destination device to have the data copy function with reference to the copy command and the connected device management file; and a copy command issuance program for issuing a copy command to the selected device selected by the device selection program.

According to still yet another aspect of the present invention, there is also provided a recording media for recording a program for copying data for use in connecting a host system with a plurality of devices through an interface, the program being for use in copying data between the a plurality of devices based on a copy command produced in the host system, the copy command designating a copy source device and a copy destination device among the a plurality of devices, a copy manager being connected with the interface, the copy manager being capable of data copy between the a plurality of devices by no way of the host system, at least one of the copy source device and the copy destination device being provided with data copy function to copy the data between the a plurality of devices by no way of the host system, the program comprising: a management file producing program for constituting a connected device management file in a memory of the host system, the connected device management file storing whether or not each of the a plurality of devices has the data copy function; a device selection program for selecting the copy source device or the copy destination device which has the data copy function, if at least one of the copy source device and the copy destination device has the data copy function, and selecting the copy manager, if neither the copy source device nor the copy destination device has the data copy function with reference to the copy command and the connected device management file; and a copy command issuance program for issuing a copy command to the selected device selected by the device selection program.

According to further yet another aspect of the present invention, there is also provided a recording media for recording a program for copying data for use in connecting a host system with a plurality of devices through an interface, the program being for use in copying data between the a plurality of devices based on a copy command produced in the host system, the copy command designating a copy source device and a copy destination device among the a plurality of devices, a copy manager being connected with the interface, the copy manager being capable of data copy between the a plurality of devices by no way of the host system, at least one of the copy source device and the copy destination device being provided with data copy function and data transfer function, the data copy function being capable of copying data between the a plurality of devices by no way of the host system while the data transfer function being capable of transferring data between the a plurality of devices; the program comprising: a management file producing program for constituting a connected device management file in a memory of the host system, the connected device management file storing whether or not each of the a plurality of devices has the data copy function and whether or not each of the a plurality of devices has the data transfer function, a device selection program for selecting the copy source device or the copy destination device which has the data copy function, if at least one of the copy source device and the copy destination device has the data copy function, selecting the copy source device and the copy destination device which has the data transfer functions, if the copy source device and the copy destination device have the data transfer functions, and selecting the copy manager, if neither the copy source device nor the copy destination device has the data copy function and the data transfer function with reference to the copy command and the connected device management file; and a copy command issuance program for issuing a copy command to the selected device selected by the device selection program, if the selected device is being provided with the data copy function or is a copy manager, issuing a read command to the copy source device while issuing a write command to the copy destination device, if the selected device is being provided with the data transfer function, so that the data transfer functions are started to copy the data.

In addition, the program is not restricted to a program recorded in a recording media, the program may be a program itself carried out by a computer.

### BRIEF DESCRIPTION OF THE DRAWINGS

FIG. 1 is a schematic conceptional view for showing a conventional method of copying data in a backup of data between auxiliary storage devices for computers, for example, a magnetic disk and a magnetic tape;

FIG. 2 is a schematic conceptional view for showing a data copy conducted by the Extended Copy command in SCSI-3 standard;

FIG. 3 is a schematic conceptional view for showing a data copy in case that the “Copy Manager” is provided;

FIG. 4 is a schematic block diagram for showing functions required for conducting a data copy by the use of “Copy Manager”;

FIG. 5 is a schematic conceptional view for showing a data copy between many devices in case that the “Copy Manager” is provided;

FIG. 6 is a flow chart for schematically showing processing when data copy is conducted by the use of “Copy Manager”;

FIG. 7 is a schematic conceptional view for showing data copy function by a control device for controlling a magnetic disk or a magnetic tape;

FIG. 8 is a schematic conceptional view for showing function of “Copy Manager”;

FIG. 9 is a schematic block diagram for showing a function of the method of copying data according to the first embodiment of the present invention;

FIG. 10 is a schematic conceptional view for showing a flow of data in case that the method of copying data according to the first embodiment of the present invention is applied;

FIG. 11 is a flow chart for schematically showing processing required for conducting the method of copying data according to the first embodiment of the present invention;

FIG. 12 is a flow chart for showing a part of the processing illustrated by the flow chart of FIG. 11;

FIG. 13 is a flow chart for schematically showing processing required for conducting the method of copying data according to the second embodiment of the present invention;.

FIG. 14 is a flow chart for schematically showing processing required for conducting the method of copying data according to the third embodiment of the present invention;

FIG. 15 is a flow chart for showing a part of the processing illustrated by the flow chart of FIG. 14; and

FIG. 16 is a schematic conceptional view for showing a flow of data in case that the method of copying data according to the third embodiment of the present invention is applied.

### DESCRIPTION OF THE PREFERRED EMBODIMENTS

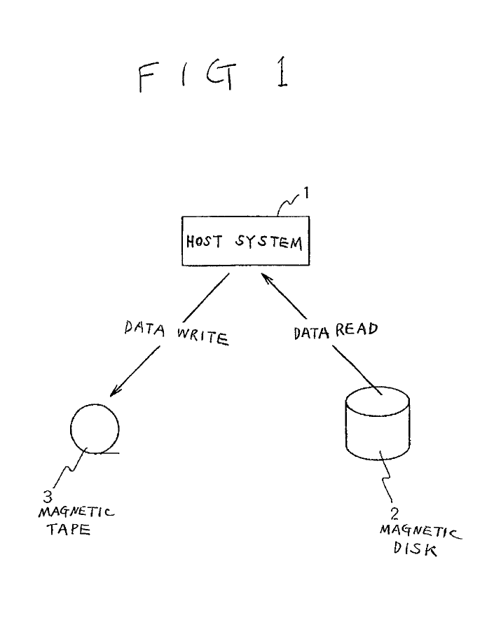

Referring to FIGS. 1 through 8, description is, at first made about a conventional method of copying data in order to facilitate an understanding of the present invention.

FIG. 1 is a schematic conceptional view for showing a conventional method of copying data in a backup of data between auxiliary storage devices for computers, for example, a magnetic disk and a magnetic tape.

In FIG. 1, illustrated is an example for showing such a backup of data from a magnetic disk 2 to a magnetic tape 3. As mentioned in the preamble of the instant specification, such a kind of method of copying data is generally achieved by a host system 1 for controlling backup operation that reads data from the magnetic disk 2 and then writes the data to a magnetic tape 3. However, in the method illustrated in FIG. 1, since the host system 1 once must read the data to be copied, the host system 1 is subjected to the load. The other requirements for processing by the host system 1 are threatened to be delayed while the host system 1 is copying the data. In such a data copy, the host system 1 is subjected to the load, although the host system 1 does not need the data to be copied but only conveys the data from the magnetic disk 2 to the magnetic tape 3.

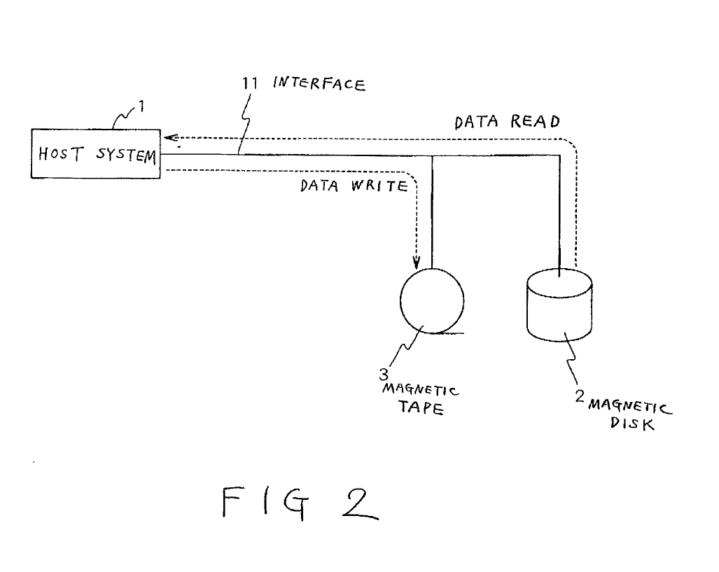

Similarly to the above-mentioned method of copying data proposed in the unexamined Japanese patent publication No.H06-236340, an improved data copy order is proposed in standard in order to reduce the load on such a host system. According to the data copy order, data copy is conducted without conveyance of data by the host system. For example, Extended Copy command is provided in SCSI-3 standard. FIG. 2 is a schematic conceptional view for showing a data copy conducted by the Extended Copy command in SCSI-3 standard. In the Extended Copy command, it is assumed that the magnetic disk 2 as a copy source and the magnetic tape 3 as a copy destination are connected to the same interface, as illustrated in FIG. 2. However, even in the structure illustrated in FIG. 2, the host system 1 reads data from the magnetic disk 2 and then writes the data to the magnetic tape 3, when data backup from the magnetic disk 2 to the magnetic tape 3 is conducted. The host system 1 is subjected to the considerable load, since the host system 1 conveys the data from the magnetic disk 2 to the magnetic tape 3.

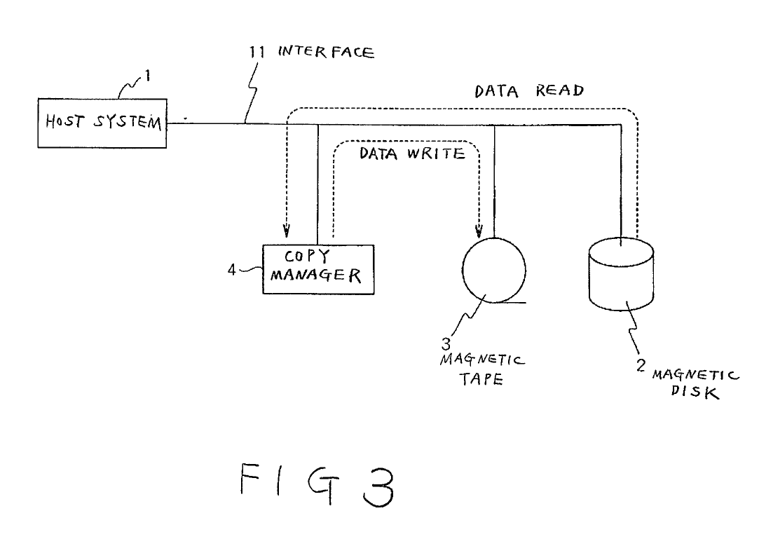

According to the data copy order in which data copy is conducted without conveyance of the data by the host system, both a copy source and a copy destination are indicated in the data copy order. Therefore, it becomes possible to copy the data without conveyance of the data by the host system that has made the data copy order. A section that conducts the data copy in response to the data copy order is called “Copy Manager”. FIG. 3 is a schematic conceptional view for showing a data copy in case that the “Copy Manager” is provided. As illustrated in FIG. 3, upon receiving an order from the host system 1, the Copy Manager 4 reads data from the magnetic disk 2 as a copy source and then writes the data to the magnetic tape 3 as a copy destination. As a result, the load on the host system 1 is so reduced. Such a method for reducing the load on the host system by the use of “Copy Manager” has been employed in software for backup control.

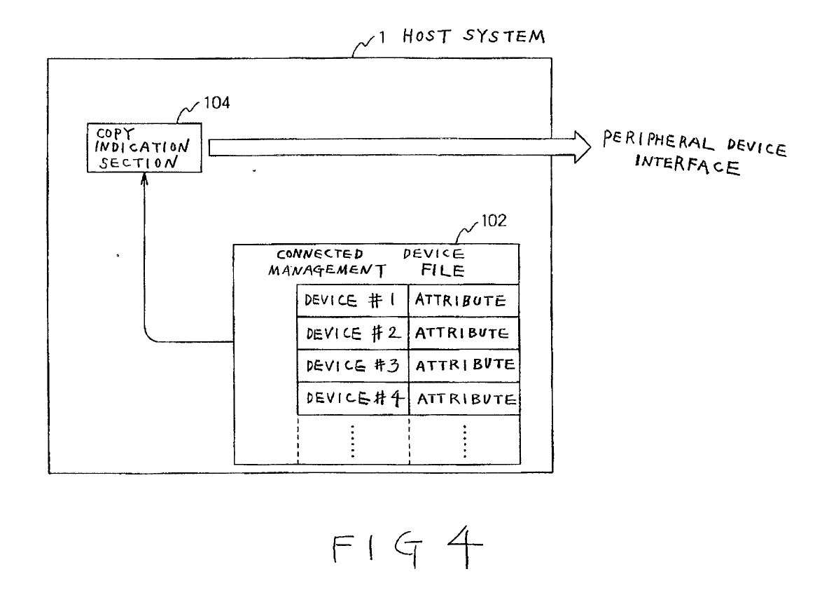

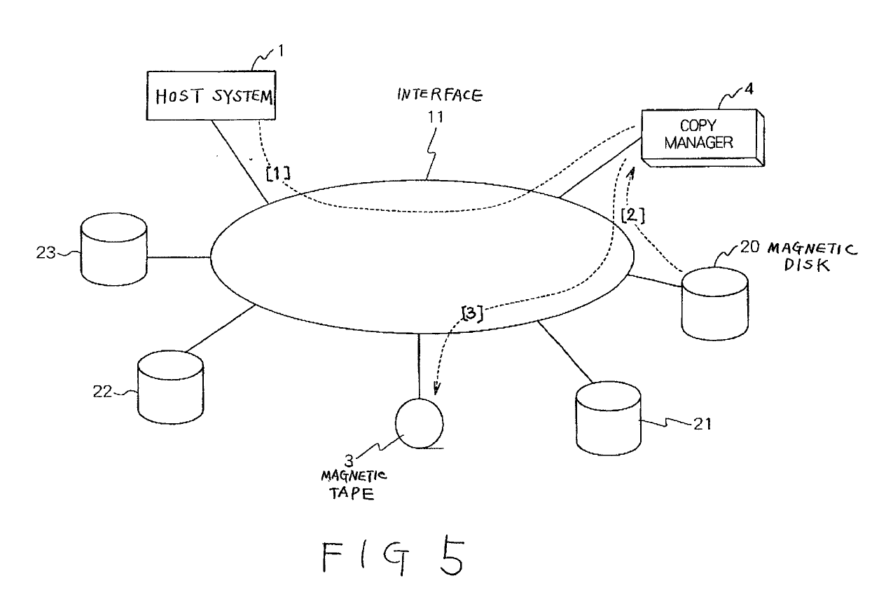

FIG. 4 is a schematic block diagram for showing functions required for conducting a data copy by the use of “Copy Manager”. FIG. 5 is a schematic conceptional view for showing a data copy between many devices in case that the “Copy Manager” is provided. In FIG. 5, the host system 1, the magnetic disks 20, 21, 22, 23, the magnetic tape 3, and the Copy Manager 4 are connected with each other through an interface 11. In FIG. 5, the host system 1 has the functions shown by the schematic block diagram illustrated in FIG. 4. In FIG. 4, a connected device management file 102 is a table for managing a type and a distinction ID (address) of each peripheral device, such as the magnetic disks 20, 21, 22, 23 connected with the interface 11. In addition, a copy indication section 104 is a source for generating a data copy demand. Concretely speaking, the copy indication section 104 corresponds to backup software or various application programs.

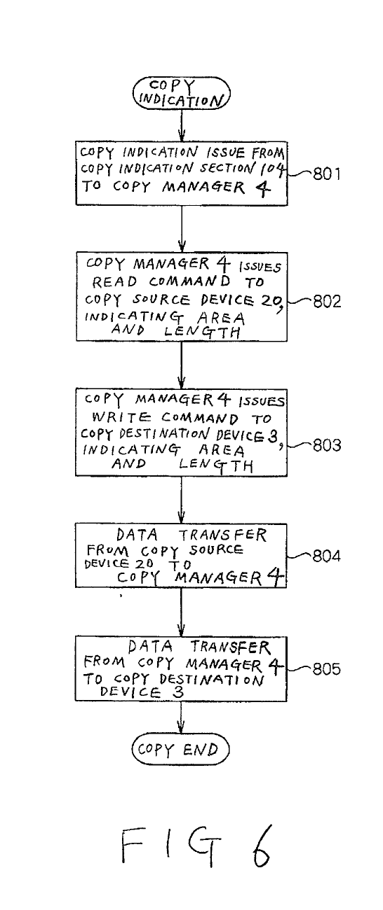

Next, referring to FIG. 6 with reference to FIGS. 4 and 5 continued, description proceeds to flow of the processing and the data in a data copy by the use of “Copy Manager”.

In FIG. 4, the copy indication section 104 generates a data copy demand which includes necessary information for copying data, such as “copy source device”, “data area in copy source device”, “data length to be copied”, “copy destination device”, “data area in copy destination device” and the like. The copy indication section 104 searches an address of the Copy Manager 4 based on the information stored in the connected device management file 102. The copy indication section 104 then sends the above-mentioned necessary information for copying data to the Copy Manager 4 and indicates the Copy Manager 4 to copy the data.

In FIG. 6, illustrated is a flow of processing as regards an example in which data backup is conducted from the magnetic disk 20 to the magnetic tape 3. A copy demand generated in the copy indication section 104 is issued towards the Copy Manager 4 (Step 801 of FIG. 6/[1] of FIG. 5).

The Copy Manager 4 analyzes the copy demand to acquire the necessary information for copying data. As a result, the Copy Manager 4 issues a command for reading data in the area to be copied towards the copy source device (the magnetic disk 20) (Step 802 of FIG. 6). At the same time, the Copy Manager 4 issues a command for writing data towards the copy destination device (the magnetic tape 3) (Step 803 of FIG. 6). Thereafter, the Copy Manager 4 receives the data sent from the magnetic disk 20 (Step 804 of FIG. 6/[2] of FIG. 5). The Copy Manager 4 then transfers the data to the magnetic tape 3 (Step 805 of FIG. 6/[3] of FIG. 5).

According to the method using the Copy Manager, the load on the host system can be reduced, when many auxiliary storage devices are directly connected to a network and a great amount of data are transferred and copied between the magnetic disk and the magnetic tape, as illustrated in FIG. 5. However, as will be understood from FIGS. 3 and 5, the Copy Manager 4 is further required in addition to resources for storing data (the magnetic disk, the magnetic tape, and the like) in the system. As a result, system cost is so increased. In other words, the Copy Manager 4 is merely, as an alternative system for taking over the load of copying data on the host system, connected with the same interface.

In the interim, the Copy Manager 4 in the above-mentioned standard must not exist as an independent resource, as illustrated in FIG. 5. The Copy Manager 4 can be located anywhere in the same interface. Further, a control device for controlling the magnetic disks 20 to 23 and the magnetic tape 3 can function as the Copy Manager 4, only if the control device is capable of transferring data from the indicated copy source to the indicated copy destination.

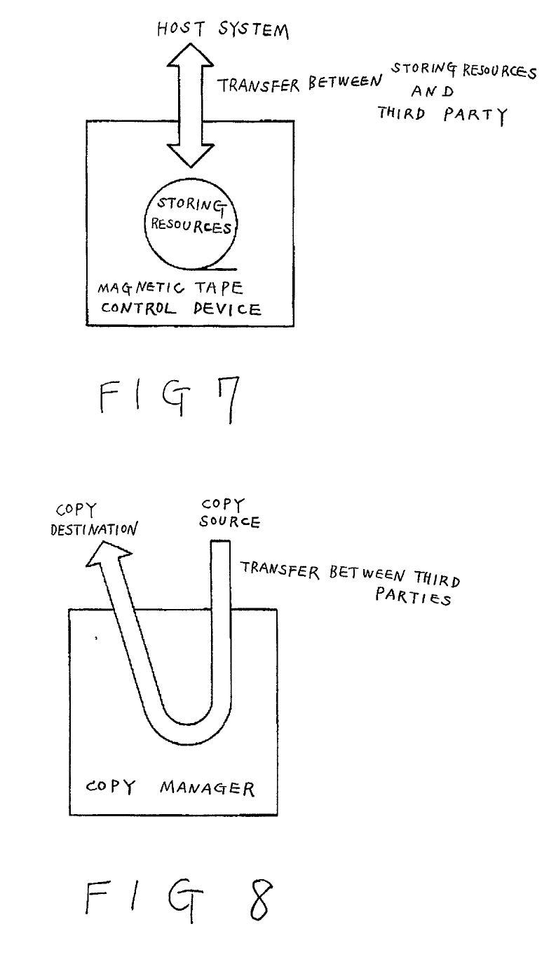

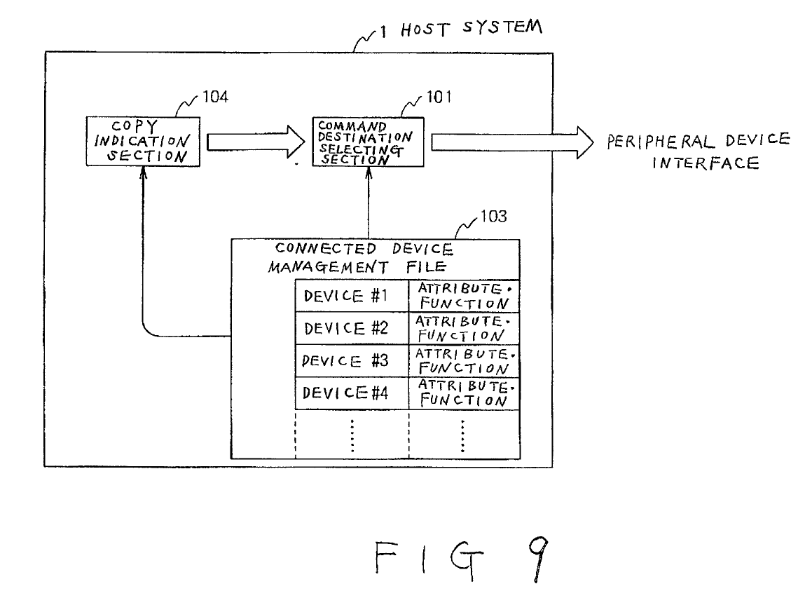

However, the control device for controlling the magnetic disks 20 to 23 and the magnetic tape 3 generally controls data transfer between the host system and such storing resources under the control of the control device and directly recognized by the host system as magnetic disks and magnetic tapes, as illustrated in FIG. 7. On the contrary, Copy Manager controls data transfer between other devices except for the Copy Manager itself, as illustrated in FIG. 8. Thus, a function of the Copy Manager is completely different from that of the control device for controlling the magnetic disks 20 to 23 and the magnetic tape 3. Therefore, even if the function of the Copy Manager is added to the control device for controlling the magnetic disks 20 to 23 and the magnetic tape 3, a plurality of different functions from each other merely turn out to be independently incorporated in a single device. Consequently, increase of development cost and product cost is inevitably caused to occur.

As described above, an alternative system for taking over the load of copying data on the host system is merely added to the network, even if an independent Copy Manager is connected to the interface or similar function is supplied to the control device for controlling the magnetic disks 20 to 23 and the magnetic tape 3. This causes a problem that the load on the whole of the network still unchanged.

Further, as will be understood by comparison of FIG. 2 with FIG. 3, only one difference is whether the host system 1 or the Copy Manager 4 carries out reading of data from the copy source and writing of data to the copy destination. If the same amounts of data are copied either in FIG. 2 or in FIG. 3, use rate of the interface in FIG. 2 or in FIG. 3 is not different from each other. Accordingly, load on the interface is never reduced.

On the other hand, a method for transferring data is disclosed in the above-mentioned unexamined Japanese patent publication No.H06-236340. The method is restricted to control for transferring data between a specific storing resource and the other devices. The method can be employed in a network system using a large computer, such as a mainframe, or the like, since auxiliary storage devices connected to a host computer can be restricted to some extent in such a network system using the large computer. However, in an open system that has been increased in recent years, data transfer between peripheral devices is not always supported by the peripheral devices connected to the open system. As a result, Copy Manager cannot but be incorporated in the open system for general-purpose backup software. Consequently, it is difficult to reduce use rate of the interface.

Now, referring to FIGS. 9 through 12, description will proceed to a method of copying data according to a first embodiment of the present invention.

FIG. 9 is a schematic block diagram for showing a function of the method of copying data according to the first embodiment of the present invention.

Besides, according to a definition regarding Copy Manager in SCSI-3 standard, a function of the Copy Manager, that is “a function to read data from any devices and then write the data to any devices” is called “Third Party Copy”. In the definition in SCSI-3 standard, “any devices” may be either an own device and the other device. However, hereinafter in the description for the method of copying data according to the first embodiment of the present invention, a term “third party copy” is restrictedly used for “a function to copy data between an own device and the other device”. In other words, “third party copy” do not need to have a function to copy data between the other devices. The “data copy function” in claims means “third party copy” thus described.

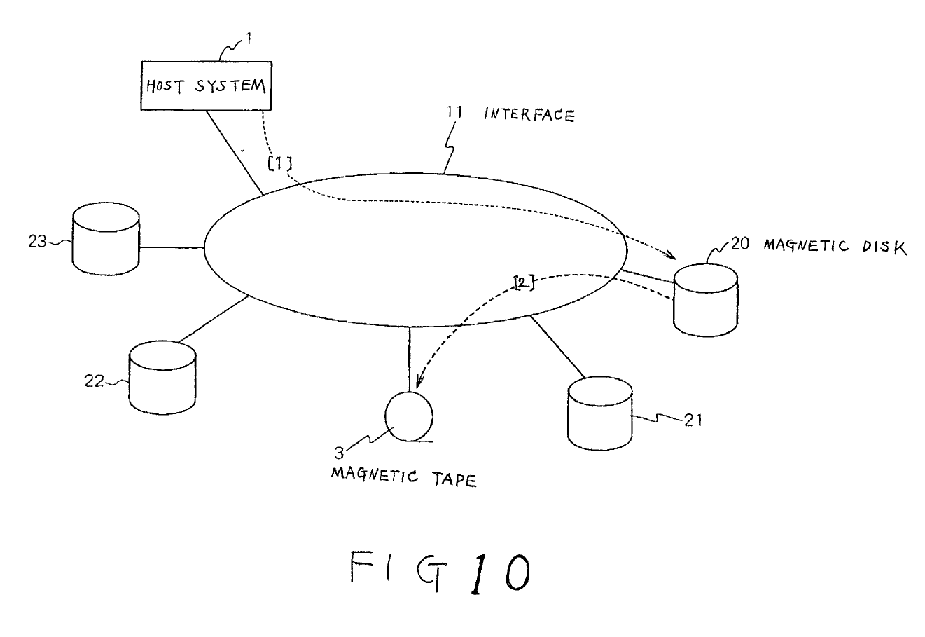

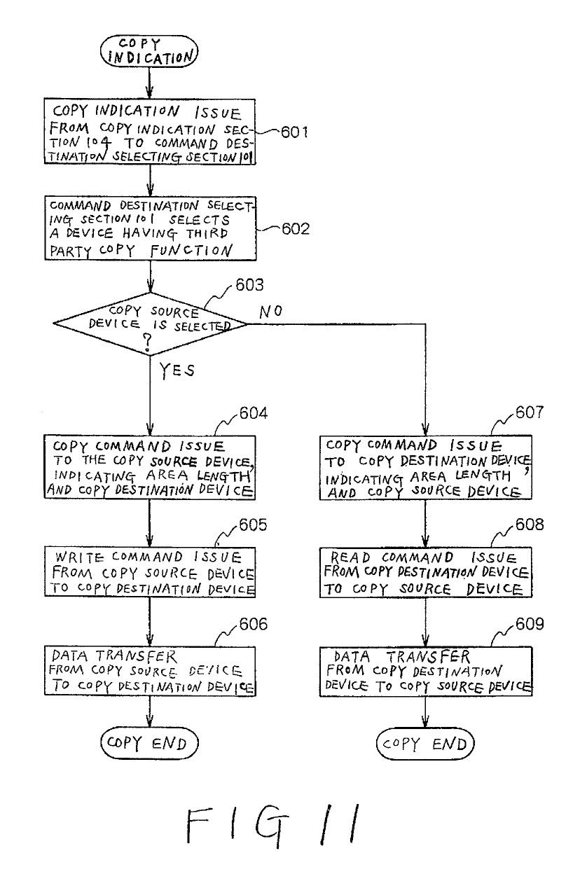

FIG. 10 is a schematic conceptional view for showing a flow of data in case that the method of copying data according to the first embodiment of the present invention is applied.

In FIG. 10, the host system 1 has the functions shown by the schematic block diagram illustrated in FIG. 9. In FIG. 9, a connected device management file 103 is a table for managing information of a type and a distinction ID (address) of each peripheral device, such as the magnetic disks 20, 21, 22, 23 connected with the interface 11. Further, the connected device management file 103 is also a table for managing information whether or not each peripheral device has a function of the third party copy (a function to copy data). A command destination selecting section 101 is means for selecting a device to which a copy indication (copy command) generated by a copy indication section 104 is issued. The command destination selecting section 101 is consisting substantially of a device selection program and a copy command issue program both of which are installed into the host system 1. In addition, the copy indication section 104 is a source for generating a data copy demand. Concretely speaking, the copy indication section 104 corresponds to backup software or various application programs, similarly to the conventional example. In this embodiment, it is assumed that either a copy source device or a copy destination device always include the function of the third party copy (a function to copy data).

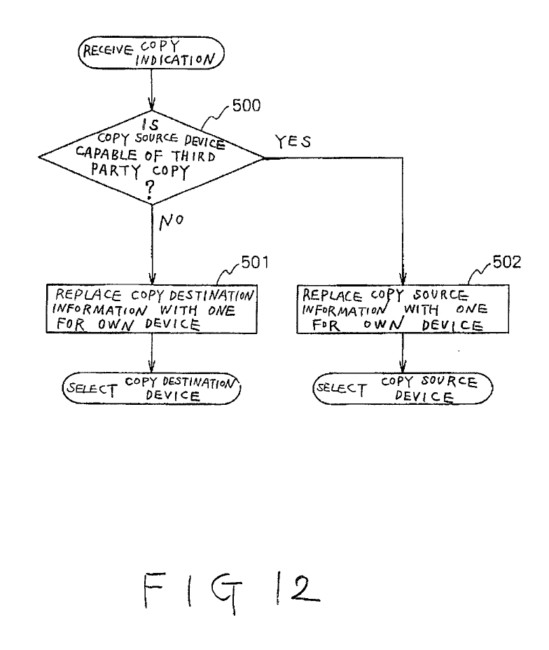

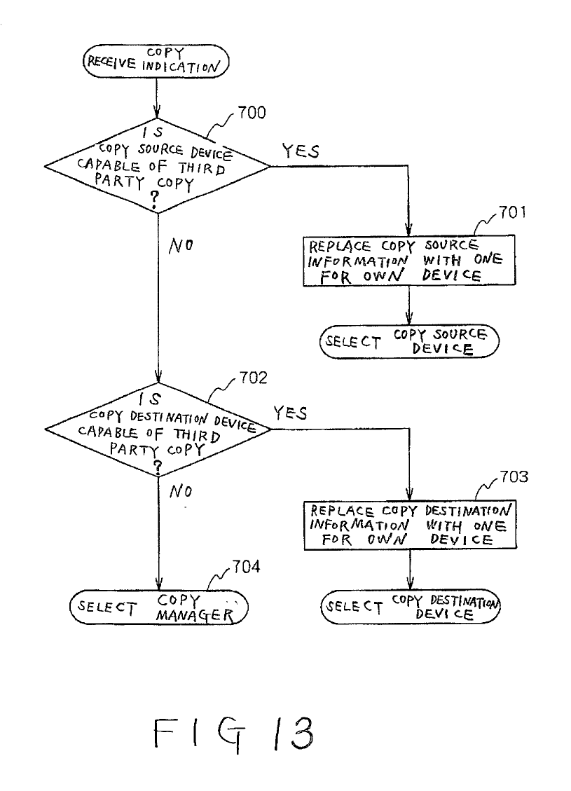

Next, referring to FIGS. 11 and 12 with reference to FIGS. 9 and 10 continued, description is made about operations in the method of copying data according to this embodiment and data flow therein.

FIG. 11 is a flow chart for schematically showing processing required for conducting the method of copying data according to the first embodiment of the present invention. FIG. 12 is a flow chart for showing a part of the processing illustrated by the flow chart of FIG. 11.

In FIG. 9, similarly to the conventional example mentioned above, the copy indication section 104 generates a copy indication command which includes necessary information for copying data, such as “copy source device”, “data area in copy source device”, “data length to be copied”, “copy destination device”, “data area in copy destination device” and the like. The copy indication section 104 then issues the copy indication command to the command destination selecting section 101 (Step 601). At that time, the copy indication section 104 may not designate the destination of the copy indication. Further, in consideration of interchangeability with the conventional method of copying data, the copy indication section 104 may issue the copy indication command to a Copy Manager, presuming that the Copy Manager imaginary exists.

The device selection program as the command destination selecting section 101 refers the connected device management file 103 to obtain the information thereof. Among the information, as an issue destination of copy indication, the device selection program selects “copy source device” or “copy destination device” either of which has a third party copy function (data copy function) (Step 602). Judgement process for selecting the issue destination of copy indication is depicted in FIG. 12. If the copy source device has the third party copy function (data copy function), the copy source device is selected as the issue destination of copy indication. Further, the information “copy source device”, “data area in copy source device”, “length of data to be copied”, “copy destination device” and “data area in copy destination device” received from the copy indication section 104 are replaced with the another information “data area to be transferred”, “length of data to be transferred”, “write destination device” and “data area in the write destination device” (Step 500, 501).

On the other hand, if the copy source device does not have the third party copy function (data copy function), in other words, if the copy destination device has the third party copy function (data copy function), the copy destination device is selected as the issue destination of copy indication. Further, the information “copy source device”, “data area in copy source device”, “length of data to be copied”, “copy destination device” and “data area in copy destination device” received from the copy indication section 104 are replaced with the another information “read source device”, “data area in the read source device”, “length of data to be read”, and “data area in which reception data are written” (Step 500, 502).

The copy command issue program as the command destination selecting section 101 judges whether the device selected in the above-mentioned process of Step 602 is copy source device or copy destination device (Step 603). The copy command issues program issues the copy indication command to the selected device (Step 604 or 607).

For example, when “copy source device” is selected as the issue destination of copy indication command, that is, when judgement of Step 603 results in “YES”, the copy indication command is issued to the “copy source device” (Step 604/[1] of FIG. 10).

In this case, the copy source device (magnetic disk 20) which has received the copy indication command issues WRITE command to a designated “write destination device” (Step 605) and transfers data to “data area in the write destination device” (Step 606/[2] of FIG. 10). A function to issue WRITE command is included in the third party copy function (data copy function) of the copy source device.

On the other hand, when “copy destination device” is selected as the issue destination of copy indication command, that is, when judgement of Step 603 results in “NO”, the copy indication command is issued to the “copy destination device” (Step 607). In this case, the copy destination device which has received the copy indication command issues READ command to a designated “read source device” (Step 608) and read the data from “data area in the read source device” to copy the data to the copy destination device (Step 609). A function to issue READ command is included in the third party copy function (data copy function) of the copy destination device.

Thus, in the method of copying data according to this embodiment, the command destination selecting section 101 selects a device having third party copy function (data copy function) and issues the copy indication to the device with reference to information of the connected device management file 103. Even if Copy Manager does not exist in the same interface, data copy can be carried out without load on the host system 1.

Further, it is not necessary for a control device controlling a magnetic disk, a magnetic tape, and the like to be provided with a function of Copy Manager that requires data copy function between other devices. The method of copying data according to the first embodiment can be realized by a function only capable of data transfer between the own device and the other device, that is, such a function as required for general auxiliary storage devices. It is not necessary to employ peripheral devices of high cost, in order that a network system may be constructed by the use of the method of copying data according to the first embodiment.

Moreover, as will be understood from comparison of FIG. 10 with FIG. 5, in the conventional method of copying data illustrated in FIG. 5, transfers of data are carried out twice in the interface 11, the first transfer is from the magnetic disk 20 to the Copy Manager 4 ([2] in FIG. 5) while the second transfer is from the Copy Manager 4 to the magnetic tape 3 ([3] in FIG. 5). On the other hand, in the method of copying data according to the first embodiment illustrated in FIG. 10, transfer of data is carried out once in the interface 11, that is from the magnetic disk 20 to the magnetic tape 3 ([2] in FIG. 110). This enables amount of data transferred in the interface 11 to be reduced to a half extent. This results in that use rate (busy rate) of the interface 11 by the method illustrated in FIG. 10 is as half as that by the conventional method illustrated in FIG. 5, even if the same processing are carried out in both the methods. Accordingly, twice as much capacity as the conventional one can be achieved in an interface by the method according to the first embodiment illustrated in FIG. 10, even if the interface has the same data transfer capacity as that of the conventional one. Moreover, since the number of times for data transfer becomes as half as the conventional one, transfer troubles that are threatened to be generated during transfer of data, such as parity error, CRC error, or the like can be reduced to a half extent.

Besides, in the first embodiment, peripheral devices connected to the interface are auxiliary storage devices, such as a magnetic disk, a magnetic tape, and the like. The peripheral devices are not restricted to the storage devices. The peripheral devices may be output or display devices, such as a printer or a display device.

Furthermore, in the first embodiment, either the copy source device or the copy destination device always include the function of the third party copy (a function to copy data) within peripheral devices connected to the interface 11. This does not mean that all devices connected to the interface must have the function of the third party copy (a function to copy data). For example, in the structure illustrated in FIG. 10, in a case that data copy is always carried out in the manner of either data backup from the magnetic disks 20, 21, 22, 23 to the magnetic tape 3 or data restoring from the magnetic tape 3 to the magnetic disks 20, 21, 22, 23, only the magnetic tape 3 may have the function of the third party copy (a function to copy data).

However, in the structure illustrated in FIG. 10, if the magnetic disks 20, 21, 22, 23 do not have the function of the third party copy (a function to copy data) but only the magnetic tape 3 has the function of the third party copy (a function to copy data), data copy can never be carried out between the magnetic disks 20, 21, 22, and 23 to each other. In order to enable the data copy between the magnetic disks 20, 21, 22, and 23 to each other, it becomes necessary to include the Copy Manager that enables data copy between other devices, similarly to the conventional structure illustrated in FIG. 5.

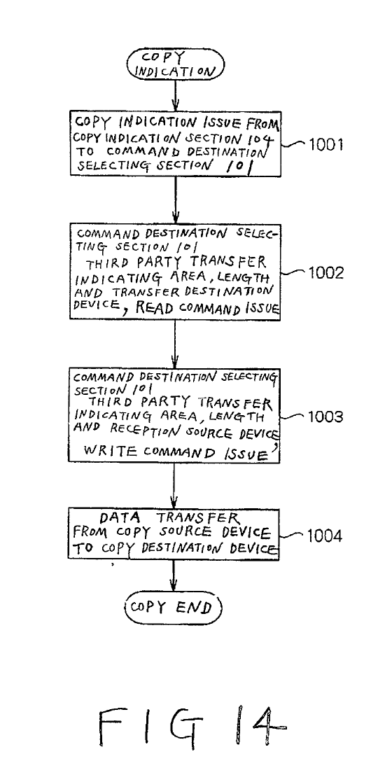

Next, referring to FIG. 13, description will proceed to a method of copying data according to a second embodiment of the present invention. FIG. 13 is a flow chart for schematically showing processing required for conducting the method of copying data according to the second embodiment of the present invention. In the second embodiment, the method of copying data of the present invention is applied to the structure including the Copy Manager 4, as illustrated in FIG. 5.

Herein, it is assumed that the magnetic disks 20, 21, 22, 23 do not have the function of the third party copy (a function to copy data) but only the magnetic tape 3 has the function of the third party copy (a function to copy data). Referring to the flow chart of FIG. 13 with reference to FIGS. 9 and 10 continued, description is hereinunder made about operations of the command destination selecting section 101 in this case.

In FIG. 9, similarly to the first embodiment mentioned above, the copy indication section 104 generates a copy indication command which includes necessary information for copying data, such as “copy source device”, “data area in copy source device”, “data length to be copied”, “copy destination device”, “data area in copy destination device” and the like. The copy indication section 104 then issues the copy indication command to the command destination selecting section 101.

When “copy source device” is the magnetic tape 3 while “copy destination device” is the magnetic disk 20, 21, 22, or 23, that is, in a case of data restoring from the magnetic tape 3 to the magnetic disk 20, 21, 22, or 23, the function of the third party copy (a function to copy data) is included in the copy source device through the judgement of Step 700. The information “copy source device”, “data area in copy source device”, “length of data to be copied”, “copy destination device” and “data area in copy destination device” received from the copy indication section 104 are replaced with the another information “data area to be transferred”, “length of data to be transferred”, “write destination device” and “data area in the write destination device” (Step 701). The copy indication section 104 issues the copy indication command to the magnetic tape 3. A flow of processing in this case is similar to that illustrated in FIG. 11 (Step 604-606).

On the other hand, when “copy source device” is the magnetic disk 20, 21, 22, or 23 while “copy destination device” is the magnetic tape 3, that is, in a case of data backup from the magnetic disk 20, 21, 22, or 23 to the magnetic tape 3, the function of the third party copy (a function to copy data) is not included in the copy source device, namely the magnetic disk 20, 21, 22, or 23 through the judgement of Step 700. Consequently, the copy destination device is judged (Step 702). The function of the third party copy (a function to copy data) is included in the copy destination device, namely the magnetic tape 3. As a result, the information “copy source device”, “data area in copy source device”, “length of data to be copied”, “copy destination device” and “data area in copy destination device” received from the copy indication section 104 are replaced with the another information “read source device”, “data area in the read source device”, “length of data to be read”, and “data area in which reception data are written” (Step 703). The copy indication section 104 issues the copy indication command to the magnetic tape 3. A flow of processing in this case is similar to that illustrated in FIG. 11 (Step 607-609).

Different from the cases mentioned above, when both “copy source device” and “copy destination device” are the magnetic disk 20, 21, 22, or 23, both the copy source device and the copy destination device are judged to be a device incapable of the third party copy (data copy) in either Step 700 and Step 702. The device selection program as the command destination selecting section 101 selects the Copy Manager 4 as an issue destination of copy indication command. The copy command issue program as the command destination selecting section 101 issues the information received from the copy indication section 104 to the Copy Manager 4 as it stands (Step 704).

In this embodiment, it is necessary to include the Copy Manager 4 within the system, similarly to FIG. 5. However, in this embodiment, the command destination selecting section 101 (device selection program and copy command issue program) and the connected device management file 103 each of which is an element of the method of copying data of the present invention are added to the system. As a result, only if either the copy source device or the copy destination device has the third party copy function (data copy function), data copy processing can do without the Copy Manager 4. This brings meritorious effects that use rate (busy rate) of the interface 11 can be reduced.

In the first and second embodiments mentioned above, it is assumed that at least either the copy source device or the copy destination device has the third party copy function (data copy function).

In the interim, functions at least required for an auxiliary storage device are to write data into a memory area of its own device (WRITE) and to read the data from the memory area of the own device (READ). These functions are composed of three elements, those are;

1) to receive a command from an upper device

2) to receive data from an upper device to a memory area of its own device (WRITE) or to transmit data from a memory area of its own device to an upper device (READ)

3) to report end to an upper device

On the other hand, functions of the Copy Manager are composed of four elements, those are;

1) to receive a command from an upper device

2) to receive data from the other device

3) to transmit data to the other device

4) to report end to an upper device

Let the functions of the auxiliary storage device be compared with the functions of the Copy Manager. The functions of the auxiliary storage device include a function to designate a memory area of its own device, that is not included in the functions of the Copy Manager. On the other hand, the functions of the Copy Manager include a function to receive data from the other device and a function to transmit data to the other device, those are not included in the functions of the auxiliary storage device. In these points, the functions of the auxiliary storage device and the functions of the Copy Manager are far different from each other. As a result, if we want the functions of the Copy Manager to be added to the auxiliary storage device, two independent functions, namely to receive data from the other device and to transmit data to the other device must be included therein, in addition to the conventional functions.

However, the function of the third party copy (a function to copy data) in the first and the second embodiments is such a function to copy data between a memory area of its own device and a memory area of designated the other device by a command from an upper device. Namely, the function of the third party copy (a function to copy data) is composed of four elements, those are;

1) to receive a command from an upper device

2) to issue READ command to the other device (when its own device is a copy destination device) or to issue WRITE command to the other device (when its own device is a copy source device)

3) to receive data from the other device to a memory area of its own device (when its own device is a copy destination device) or to transmit data from a memory area of its own device to the other device (when its own device is a copy source device)

4) to report end to an upper device

When compared with READ/WRITE functions at least required for an auxiliary storage device, the function of the third party copy (the function to copy data) has only differences that a process to issue a copy command to the other device is added and that destination of data transfer is not an upper device but the other auxilialy storage device. Thus, the function of the third party copy (the function to copy data) is substantially equal to that of the conventional auxiliary storage device. Accordingly, it is not difficult for the function of the third party copy (the function to copy data) to be included in the auxiliary storage device.

In the method of copying data described in the first and the second embodiments mentioned above, data copy is carried out by the use of this function readily added to the auxiliary storage device without load on a host system. Data copy can thereby be carried out without an independent function of Copy Manager.

Furthermore, Third Party Transfer can be used as the function readily added to the auxiliary storage device. The function of Third Party Transfer is composed of three elements, those are;

1) to receive a command from an upper device

2) to receive data from the other device to a memory area of its own device (WRITE) or to transmit data from a memory area of its own device to the other device (READ)

3) to report end to an upper device

When compared with READ/WRITE functions at least required for an auxiliary storage device, the function of the Third Party Transfer is completely equal to that of the conventional auxiliary storage device, except that destination of data transfer is not an upper device but the other auxiliary storage device. When compared with the function of the third party copy (the function to copy data), the function of the Third Party Transfer is added more readily to the auxiliary storage device. The Third Party Transfer function is “data transfer function” defined in claims.

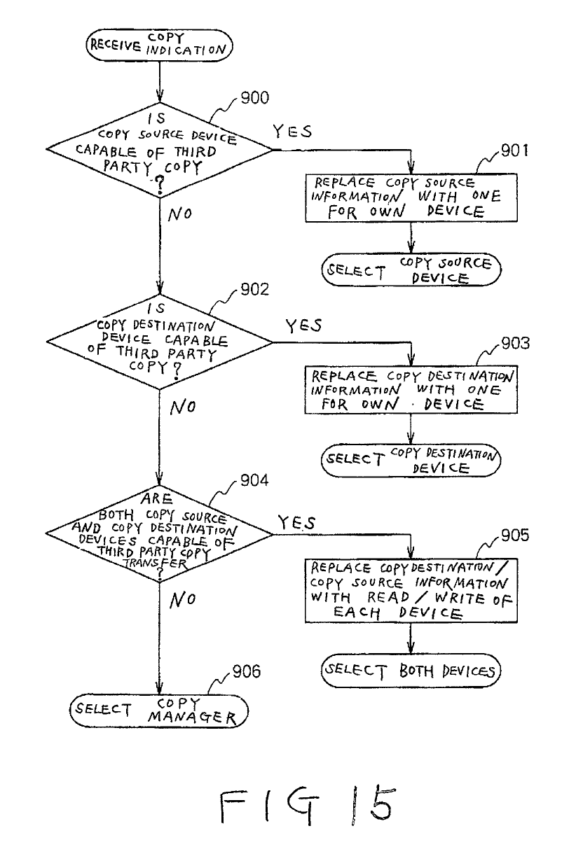

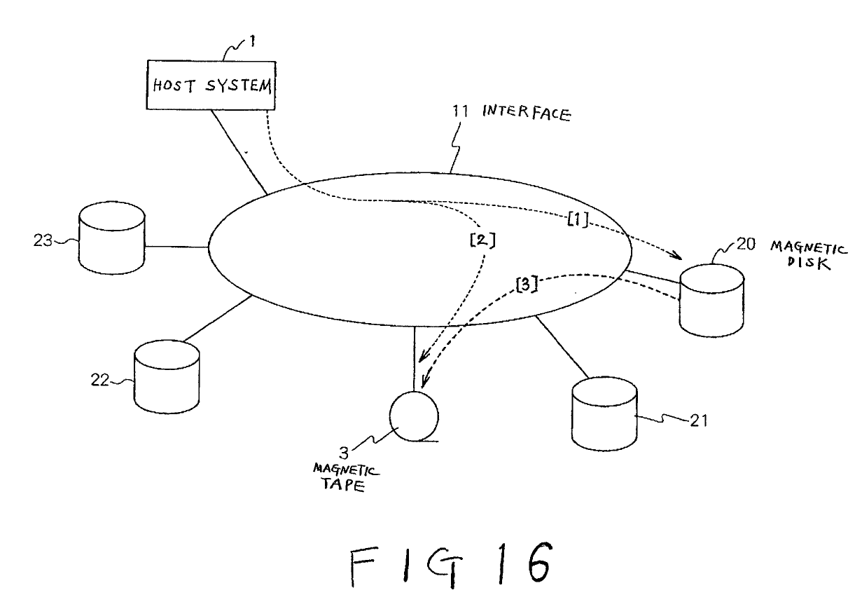

Next, referring to FIGS. 14 through 16, description will proceed to a method of copying data according to a third embodiment of the present invention. FIG. 14 is a flow chart for schematically showing processing required for conducting the method of copying data according to the third embodiment of the present invention. FIG. 15 is a flow chart for showing a part of the processing illustrated by the flow chart of FIG. 14. FIG. 16 is a schematic conceptional view for showing a flow of data in case that the method of copying data according to the third embodiment of the present invention is applied. In the third embodiment, the method of copying data of the present invention is applied to the structure utilizing the function of Third Party Transfer. In this embodiment, elements required for existing in the host system are only the command destination selecting section 101 (device selection program and copy command issue program) and the connected device management file 103. The connected device management file 103 manages not only whether or not each device connected to the interface 11 has the third party copy function (data copy function) but also whether or not each device connected to the interface 11 has the third party transfer function (data transfer function).

Besides, if the third party transfer function (data transfer function) is used, it is required that both the copy source device and the copy destination device have the third party transfer functions (data transfer functions).

Referring to FIGS. 14 through 16, description is hereinafter made about operations in a case that both the copy source device and the copy destination device do not have the third party copy functions (data copy functions) but have the third party transfer functions (data transfer functions).

The command destination selecting section 101 which has received a copy indication from the copy indication section 104 refers the connected device management file 103, based on the information for copy source device and copy destination device included in the copy indication. The command destination selecting section 101 then carries out the processing for selecting a method of copying data to be applied (Step 1001 of FIG. 14). The processing is depicted in detail in FIG. 15.

In FIG. 15, it is assumed that the copy source device and the copy destination device have only the third party transfer functions (data transfer functions). Accordingly, the copy source device and the copy destination device are judged in Step 900 and 902 not to have the third party copy functions (data copy functions). The copy source device and the copy destination device are judged in Step 904 to have the third party transfer functions (data transfer functions) (Step 904).

The command destination selecting section 101 as the device selection program and the copy command issue program select the copy source device and the copy destination device as issue destination of copy indication. Thereafter, the command destination selecting section 101 replaces information required for copying data produced in the copy indication section 104, namely information included in the copy indication, with READ command indicating third party transfer to the copy source device and WRITE command indicating third party transfer to the copy destination device (Step 905). Namely, the command destination selecting section 101 issues READ command indicating third party transfer to the copy source device, designating area from which data are read, length of data, and transfer destination device (Step 1002/[1] of FIG. 16).

On the other hand, the command destination selecting section 101 issues WRITE command indicating third party transfer to the copy destination device, designating area to which data are written, length of data, and reception source device of data (Step 1003/[2] of FIG. 16). Thereby, the copy destination device and the third party transfer function (data transfer function) thereof are driven. As a result, data transfer is carried out between the copy source device and the copy destination device, so that the data are copied (Step 1004).

In this embodiment, in FIG. 15, when the copy source device or the copy destination device has the third party copy function (data copy function), the third party copy function (data copy function) is used prior to the third party transfer function (data transfer function) (Step 900-903). In a case that the third party copy function (data copy function) is used, the processing are completely equal to those of the first and the second embodiments of the present invention. Herein, description for the case is therefore omitted.

Further, in this embodiment, it is assumed that both the copy source device and the copy destination device have the third party transfer functions (data transfer functions). When neither the copy source device nor the copy destination device has not only the third party copy function (data copy function) but also the third party transfer function (data transfer function), it can be provided that the Copy Manager 4 is included in the system, similarly to the case in the second embodiment. The Copy Manager 4 may be then selected (Step 906).

In this embodiment, when the copy source device or the copy destination device has the third party copy function (data copy function), the third party copy function (data copy function) is used prior to the third party transfer function (data transfer function) (Step 900-903). It is not necessary to use the third party copy function (data copy function) prior thereto. Alternatively, the third party transfer function (data transfer function) can be used prior to the third party copy function (data copy function).

As described above, in this embodiment, the command destination selecting section 101 (device selection program and copy command issue program) and the connected device management file 103 each of which is an element of the method of copying data of the present invention are added to the system. As a result, when both the copy source device and the copy destination device have the third party transfer functions (data transfer functions), data copy processing can do without the Copy Manager 4, similarly to the case that the third party copy function (data copy function) is used. As a result, data copy can be achieved without load on the host system 1. Further, use rate (busy rate) of the interface 11 can be reduced.

In the above embodiments, it is supposed that device selection program and copy command issue program both constituting the command destination selecting section 101 have been installed into the host system 1 and that the connected device management file 103 has already been constructed. These programs are installed into the host system 1 from a recording medium for recording a program, such as a CD-ROM, a floppy disk, and the like.

Further, the connected device management file 103 is such a file as produced within a memory of the host system i by an operation of a management file producing program installed with the device selection program and the copy command issue program. Registration for a device type and a distinction ID of each device on the connected device management file 103 may be done by manual operations of an operator by the use of man-machine interface (concretely, a display or a keyboard) of the host system 1. It may be also registered on the connected device management file 103 whether or not each device has the third party copy function or the third party transfer function by the manual operations of the operator by the use of man-machine interface (concretely, the display or the keyboard) of the host system 1. On the other hand, the host system 1 itself may search devices connected to the interface 11 in an initialization process conducted at the time of starting of the host system 1. The host system 1 thereby detects the information whether or not each device connected to the interface 11 has the third party copy function or the third party transfer function. The host system 1 then automatically register the information on the connected device management file 103.

Processing conducted by the device selection program and copy command issue program (the command destination selecting section 101), operations and effects caused by the processing are similar to those mentioned above.

What is claimed is:

1. A method of copying data for use in connecting a host system with a plurality of devices through an interface, said method being for use in copying data between said a plurality of devices based on a copy command produced in said host system, said copy command designating a copy source device and a copy destination device among said a plurality of devices, said method comprising the steps of:
providing at least one of said copy source device and said copy destination device with data copy function to copy said data between said a plurality of devices by no way of said host system;
preparing a connected device management file which stores whether or not each of said a plurality of devices has said data copy function in said host system;
selecting one of said copy source device and said copy destination device to have said data copy function with reference to said copy command and said connected device management file; and
Issuing said copy command to said copy source device or said copy destination device which has said data copy function.

2. A method of copying data for use in connecting a host system with a plurality of devices through an interface, said method being for use in copying data between said a plurality of devices based on a copy command produced in said host system, said copy command designating a copy source device and a copy destination device among said a plurality of devices, said method comprising the steps of:
connecting a copy manager with said interface, said copy manager being capable of data copy between said a plurality of devices by no way of said host system;
providing at least one of said copy source device and said copy destination device with data copy function to copy said data between said a plurality of devices by no way of said host system;
preparing a connected device management file which stores whether or not each of said a plurality of devices has said data copy function in said host system;
selecting, if at least one of said copy source device and said copy destination device has said data copy function, one of said copy source device and said copy destination device to have said data copy function with reference to said copy command and said connected device management file, so that said copy command is issued to said copy source device or said copy destination device which has said data copy function; and
selecting, if neither said copy source device nor said copy destination device has said data copy function, said copy manager, so that said copy command is issued to said copy manager.

3. A method of copying data for use in connecting a host system with a plurality of devices through an interface, said method being for use in copying data between said a plurality of devices based on a copy command produced in said host system, said copy command designating a copy source device and a copy destination device among said a plurality of devices, said method comprising the steps of:
connecting a copy manager with said interface, said copy manager being capable of data copy between said a plurality of devices by no way of said host system;
providing at least one of said copy source device and said copy destination device with either data copy function or data transfer function, said data copy function being capable of copying data between said a plurality of devices by no way of said host system while said data transfer function being capable of transferring data between said a plurality of devices;
preparing a connected device management file which stores whether or not each of said a plurality of devices has said data copy function and which stores whether or not each of said a plurality of devices has said data transfer function;
selecting, if at least one of said copy source device and said copy destination device has said data copy function, one of said copy source device and said copy destination device to have said data copy function with reference to said copy command and said connected device management file, so that said copy command is issued to said copy source device or said copy destination device which has said data copy function; and
issuing a read command to said copy source device while issuing a write command to said copy destination device, if both of said copy source device and said copy destination device have said data transfer functions, so that said data transfer functions are started to copy said data; and
selecting, if neither said copy source device nor said copy destination device has said data copy function and said data transfer function, said copy manager, so that said copy command is issued to said copy manager.

4. A recording media for recording a program for copying data for use in connecting a host system with a plurality of devices through an interface, said program being for use in copying data between said a plurality of devices based on a copy command produced in said host system, said copy command designating a copy source device and a copy destination device among said a plurality of devices, at least one of said copy source device and said copy destination device being provided with data copy function to copy said data between said a plurality of devices by no way of said host system, said program comprising:
a management file producing program for constituting a connected device management file in a memory of said host system, said connected device management file storing whether or not each of said a plurality of devices has said data copy function;
a device selection program for selecting one of said copy source device and said copy destination device to have said data copy function with reference to said copy command and said connected device management file; and
a copy command issuance program for issuing a copy command to the selected device selected by said device selection program.

5. A recording media for recording a program for copying data for use in connecting a host system with a plurality of devices through an interface, said program being for use in copying data between said a plurality of devices based on a copy command produced in said host system, said copy command designating a copy source device and a copy destination device among said a plurality of devices, a copy manager being connected with said interface, said copy manager being capable of data copy between said a plurality of devices by no way of said host system, at least one of said copy source device and said copy destination device being provided with data copy function to copy said data between said a plurality of devices by no way of said host system, said program comprising:
a management file producing program for constituting a connected device management file in a memory of said host system, said connected device management file storing whether or not each of said a plurality of devices has said data copy function;
a device selection program for selecting said copy source device or said copy destination device which has said data copy function, if at least one of said copy source device and said copy destination device has said data copy function, and selecting said copy manager, if neither said copy source device nor said copy destination device has said data copy function with reference to said copy command and said connected device management file; and
a copy command issuance program for issuing a copy command to the selected device selected by said device selection program.

6. A recording media for recording a program for copying data for use in connecting a host system with a plurality of devices through an interface, said program being for use in copying data between said a plurality of devices based on a copy command produced in said host system, said copy command designating a copy source device and a copy destination device among said a plurality of devices, a copy manager being connected with said interface, said copy manager being capable of data copy between said a plurality of devices by no way of said host system, at least one of said copy source device and said copy destination device being provided with data copy function and data transfer function, said data copy function being capable of copying data between said a plurality of devices by no way of said host system while said data transfer function being capable of transferring data between said a plurality of devices; said program comprising:
a management file producing program for constituting a connected device management file in a memory of said host system, said connected device management file storing whether or not each of said a plurality of devices has said data copy function and whether or not each of said a plurality of devices has said data transfer function,
a device selection program for selecting said copy source device or said copy destination device which has said data copy function, if at least one of said copy source device and said copy destination device has said data copy function, selecting said copy source device and said copy destination device which has said data transfer functions, if said copy source device and said copy destination device have said data transfer functions, and selecting said copy manager, if neither said copy source device nor said copy destination device has said data copy function and said data transfer function with reference to said copy command and said connected device management file; and
a copy command issuance program for issuing a copy command to the selected device selected by said device selection program, if the selected device is being provided with said data copy function or is a copy manager, issuing a read command to the copy source device while issuing a write command to the copy destination device, if the selected device is being provided with said data transfer function, so that said data transfer functions are started to copy said data.

7. A computer program for copying data for use in connecting a host system with a plurality of devices through an interface, said program being for use in copying data between said a plurality of devices based on a copy command produced in said host system, said copy command designating a copy source device and a copy destination device among said a plurality of devices, at least one of said copy source device and said copy destination device being provided with data copy function to copy said data between said a plurality of devices by no way of said host system, said computer program comprising:
a management file producing program for constituting a connected device management file in a memory of said host system, said connected device management file storing whether or not each of said a plurality of devices has said data copy function;
a device selection program for selecting one of said copy source device and said copy destination device to have said data copy function with reference to said copy command and said connected device management file; and
a copy command issuance program for issuing a copy command to the selected device selected by said device selection program.

8. A computer program for copying data for use in connecting a host system with a plurality of devices through an interface, said program being for use in copying data between said a plurality of devices based on a copy command produced in said host system, said copy command designating a copy source device and a copy destination device among said a plurality of devices, a copy manager being connected with said interface, said copy manager being capable of data copy between said a plurality of devices by no way of said host system, at least one of said copy source device and said copy destination device being provided with data copy function to copy said data between said a plurality of devices by no way of said host system, said computer program comprising:
a management file producing program for constituting a connected device management file in a memory of said host system, said connected device management file storing whether or not each of said a plurality of devices has said data copy function;
a device selection program for selecting said copy source device or said copy destination device which has said data copy function, if at least one of said copy source device and said copy destination device has said data copy function, and selecting said copy manager, if neither said copy source device nor said copy destination device has said data copy function with reference to said copy command and said connected device management file; and
a copy command issuance program for issuing a copy command to the selected device selected by said device selection program.

9. A computer program for copying data for use in connecting a host system with a plurality of devices through an interface, said program being for use in copying data between said a plurality of devices based on a copy command produced in said host system, said copy command designating a copy source device and a copy destination device among said a plurality of devices, a copy manager being connected with said interface, said copy manager being capable of data copy between said a plurality of devices by no way of said host system, at least one of said copy source device and said copy destination device being provided with data copy function and data transfer function, said data copy function being capable of copying data between said a plurality of devices by no way of said host system while said data transfer function being capable of transferring data between said a plurality of devices; said computer program comprising:
a management file producing program for constituting a connected device management file in a memory of said host system, said connected device management file storing whether or not each of said a plurality of devices has said data copy function and whether or not each of said a plurality of devices has said data transfer function,
a device selection program for selecting said copy source device or said copy destination device which has said data copy function, if at least one of said copy source device and said copy destination device has said data copy function, selecting said copy source device and said copy destination device which has said data transfer functions, if said copy source device and said copy destination device have said data transfer functions, and selecting said copy manager, if neither said copy source device nor said copy destination device has said data copy function and said data transfer function with reference to said copy command and said connected device management file; and
a copy command issuance program for issuing a copy command to the selected device selected by said device selection program, if the selected device is being provided with said data copy function or is a copy manager, issuing a read command to the copy source device while issuing a write command to the copy destination device, if the selected device is being provided with said data transfer function, so that said data transfer functions are started to copy said data.
